(19) United States
(12) Patent Application Publication
(10) Pub. No.: US 2018/0219264 A1
(43) Pub. Date: Aug. 2, 2018

(54) POWER SUPPLY SYSTEM

(71) Applicant: TOYOTA JIDOSHA KABUSHIKI KAISHA, Toyota-Shi (JP)

(72) Inventor: Michihiro Miyashita, Toyota-Shi (JP)

(73) Assignee: TOYOTA JIDOSHA KABUSHIKI KAISHA, Toyota-Shi (JP)

(21) Appl. No.: 15/876,305

(22) Filed: Jan. 22, 2018

(30) Foreign Application Priority Data
Jan. 27, 2017 (JP) 2017-012683

(51) Int. Cl. H01M 10/44; H02J 7/00; H01M 10/46; H02J 7/16; H02J 7/14; B60R 16/04; H02J 3/38; H01M 10/48

(52) U.S. Cl. CPC H01M 10/44; H02J 7/0081; H01M 10/46; H02J 7/16; H02J 2007/0067; B60R 16/04; H02J 3/387; H01M 10/48; H02J 2007/005; H02J 7/1453

(57) ABSTRACT

A power supply system includes a power generator that charges a secondary battery and a electronic control unit configured to causes the power generator to perform regenerative power generation and supply the regenerated power to the secondary battery to charge the secondary battery, cause the power generator to perform fuel power generation using power of an internal combustion engine on the basis of a power generation voltage which is set by feedback control based on a state of charge of the secondary battery and to supply the generated power to the secondary battery to charge the secondary battery, and set a lower-limit voltage for the fuel power generation to a voltage at which an amount of injected fuel in the internal combustion engine is minimized depending on an amount of the regenerated power supplied to the secondary battery.

### INCORPORATION BY REFERENCE

The disclosure of Japanese Patent Application No. 2017-012683 filed on Jan. 27, 2017 including the specification, drawings and abstract is incorporated herein by reference in its entirety.

### BACKGROUND

### 1. Technical Field

The disclosure relates to a power supply system which is mounted in a vehicle or the like, and more particularly, to control when a power generator generates electric power using power of an internal combustion engine.

### 2. Description of Related Art

In the related art, for example, as disclosed in Japanese Unexamined Patent Application Publication No. 2016-005425 (JP 2016-005425 A), a technique of charging a battery by performing regenerative power generation using an alternator (a power generator) for charging a battery (a secondary battery) or power generation (which is power generation using an output torque based on combustion of fuel) using power of an engine (an internal combustion engine) is known.

JP 2016-005425 A discloses that an upper limit value and a lower limit value of a target state of charge (SOC) of the battery is changed depending on an amount of regenerated power (an amount of electric power which is regenerated) in an immediately previous predetermined period. Specifically, when the amount of regenerated power is large, the upper limit value and the lower limit value of the target SOC are lowered and a gap between the upper limit value and the lower limit value is increased. On the other hand, when the amount of regenerated power is small, the upper limit value and the lower limit value of the target SOC are increased and the gap between the upper limit value and the lower limit value is decreased.

### SUMMARY

However, in JP 2016-005425 A, when the amount of regenerated power is large, the lower limit value of the target SOC is lowered and thus power-receiving performance of the battery is increased. Accordingly, an amount of power generated by using an output torque based on combustion of fuel (hereinafter referred to as fuel-injection power generation), which may be hereinafter referred to as an amount of fuel-injection generated power, increases and there is a likelihood that a fuel consumption rate will deteriorate.

The inventors of the disclosure has investigated decreasing an amount of fuel-injection generated power by satisfactorily acquiring an amount of generated power and thus achieving an improvement in a fuel consumption rate. The inventors have paid attention to achieving an improvement in the fuel consumption rate by optimizing a power generation voltage when fuel-injection power generation is performed.

That is, feedback control of a power generation voltage for causing an SOC of a battery to reach a target SOC is generally performed when the fuel-injection power generation is performed, but when a lower limit value of the power generation voltage (hereinafter referred to as a lower-limit voltage) at the time of the fuel-injection power generation is excessively decreased and the power generation voltage reaches the lower-limit voltage, charging of the battery is hardly performed (or an amount of power discharged from the battery increases) and the power generation voltage increases greatly due to the feedback control. In this case, the inventors of the disclosure paid attention to the fact that, even when regenerative power generation is performed thereafter, charging polarization occurs in the battery before the regenerative power generation is started and a sufficient amount of regenerated power cannot be obtained. The inventors obtained new knowledge that a sufficient amount of regenerated power can be obtained by optimizing the lower-limit voltage, an amount of fuel-injection generated power can be decreased, and thus an improvement in the fuel consumption rate can be achieved, and thus completed the disclosure.

The disclosure is made in consideration of the above-mentioned circumstances and provides a power supply system that can achieve an improvement in a fuel consumption rate by optimizing a lower-limit voltage when a power generator generates electric power using power of an internal combustion engine.

An aspect of the present disclosure relates to a power supply system. The power supply system includes a power generator configured to charge a secondary battery and an electronic control unit. The electronic control unit is configured to cause the power generator to perform regenerative power generation and supply regenerated power to the secondary battery to charge the secondary battery. The electronic control unit is configured to cause the power generator to perform fuel power generation using power of an internal combustion engine and supply generated power to the secondary battery to charge the secondary battery, the fuel power generation being performed on the basis of a power generation voltage which is set due to feedback control based on a state of charge of the secondary battery. The electronic control unit is configured to set a lower-limit voltage when the fuel power generation is performed, depending on an amount of the regenerated power supplied to the secondary battery, to a voltage at which an amount of fuel injected into the internal combustion engine is minimized.

According to the aspect, by optimizing the lower-limit voltage when the power generator performs fuel-injection power generation using power of the internal combustion engine, it is possible to prevent charging polarization from occurring in a secondary battery before regenerative power generation is started (to prevent charging polarization due to feedback control of a power generation voltage) and to acquire a sufficient amount of regenerated power at the time of regenerative power generation. Accordingly, it is possible to decrease an amount of power generated using the power of the internal combustion engine and to achieve an improvement in a fuel consumption rate.

The electronic control unit may be configured to set the lower-limit voltage to be lower when an average value of the amount of the regenerated power supplied to the secondary battery is large than when the average value of the amount of the regenerated power supplied to the secondary battery is small.

According to the aspect, in a situation in which an average amount of regenerated power is large and an amount of fuel-injection generated power can be relatively decreased, the lower-limit voltage is set to be low. Accordingly, it is possible to decrease an amount of fuel-injection generated power and to achieve an improvement in a fuel consumption rate. In a situation in which the average amount of regenerated power is small, the lower-limit voltage is set to be high. Accordingly, the charging polarization is less likely to occur.

The electronic control unit may be configured to set the lower-limit voltage to be lower when a temperature of the secondary battery is high than when the temperature is low.

When the temperature of the secondary battery is high, a chemical reaction in the secondary battery is activated, power-receiving performance is increased, and thus the lower-limit voltage is set to be low. According to the aspect, it is possible to set an optimal lower-limit voltage corresponding to the temperature of the secondary battery (a lower-limit voltage which is a lowest possible voltage within a range in which the charging polarization can be prevented) and to decrease an amount of power generated using the power of the internal combustion engine to achieve an improvement in a fuel consumption rate.

The electronic control unit may be configured to set the lower-limit voltage to be lower when an average value of a maximum value of a regenerative current in a predetermined period is large than when the average value of the maximum value of the regenerative current in the predetermined period is small, the regenerative current being a current of the regenerative power generation. The maximum value of the regenerative current may be detected every time when predetermined time elapse.

When the average value of the maximum values of the regenerative current in the regenerative power generation in a predetermined period is large, the charging polarization of the secondary battery before the regenerative power generation is started is sufficiently small and a sufficient amount of regenerated power can be obtained. Accordingly, when the average value of the maximum values of the regenerative current in the regenerative power generation in a predetermined period is large, the lower-limit voltage can be set to be lower than when the average value of the maximum values of the regenerative current in the regenerative power generation in a predetermined period is small. According to the aspect, it is possible to decrease an amount of power generated using the power of the internal combustion engine to achieve an improvement in a fuel consumption rate.

The electronic control unit may configured to set a regenerative voltage at a time of regenerative power generation to be lower when a temperature of the secondary battery is high than when the temperature of the secondary battery is low, the regenerative voltage being a voltage of the regenerative power generation.

When the temperature of the secondary battery is high, a chemical reaction in the secondary battery is activated, a charging/discharging current is increased, and deterioration of the secondary battery is likely to progress. Accordingly, when the temperature of the secondary battery is high, it is possible to minimize an increase in the charging/discharging current to make deterioration of the secondary battery less likely to progress by setting the regenerative voltage at the time of the regenerative power generation to be lower than when the temperature is low. Accordingly, according to the aspect, it is possible to extend a lifespan of the secondary battery. According to the aspect, when the temperature of the secondary battery is low, the regenerative voltage at the time of the regenerative power generation is set to be higher than when the temperature is high. Accordingly, it is possible to satisfactorily secure a state of charge of the secondary battery by obtaining a sufficient amount of regenerated power even at a low temperature at which activity of the chemical reaction in the secondary battery is low.

The electronic control unit is configured to set the regenerative voltage at the time of the regenerative power generation to be lower when an integrated value of a charging/discharging current of the secondary battery is large than when the integrated value of the charging/discharging current of the secondary battery is small.

As described above, when the charging/discharging current increases, deterioration of the secondary battery is likely to progress. Accordingly, when the integrated value of the charging/discharging current of the secondary battery is large, it is possible to minimize an increase of the charging/discharging current to make deterioration of the secondary battery less likely to progress by setting the regenerative voltage at the time of the regenerative power generation to be lower than when the integrated value of the charging/discharging current of the secondary battery is small. Accordingly, according to the aspect, it is possible to extend a lifespan of the secondary battery.

According to the disclosure, the lower-limit voltage when the power generator generates electric power using the power of the internal combustion engine is set variably to a voltage at which an amount of fuel injected into the internal combustion engine is minimized depending on an amount of regenerated power supplied to the secondary battery. Accordingly, it is possible to prevent charging polarization from occurring in the secondary battery before the regenerative power generation is started, to obtain a sufficient amount of regenerated power at the time of regenerative power generation, to decrease an amount of electric power generated using the power of the internal combustion engine, and to achieve an improvement in a fuel consumption rate.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a system configuration of a vehicle controller including a power supply system according to an embodiment;

FIG. 2 is a graph illustrating an example of changes of a battery SOC and a power generation voltage for explanation of feedback control of the power generation voltage;

FIG. 3 is a graph illustrating an example of a relationship between a lower-limit voltage of the power generation voltage and an amount of regenerated power;

FIG. 4 is a graph illustrating an example of a relationship between the lower-limit voltage of the power generation voltage and an amount of fuel-injection generated power;

FIG. 5 is a flowchart illustrating a process routine of setting a lower-limit voltage;

FIG. 6 is a graph illustrating an example of a lower-limit voltage map;

FIG. 7 is a flowchart illustrating a process routine of setting a regenerative voltage;

FIG. 8 is a graph illustrating an example of a regenerative voltage map; and

FIG. 9 is a timing chart illustrating an example of changes of a vehicle speed, an amount of injected fuel, and a power generation voltage when the lower-limit voltage of the power generation voltage is set according to the embodiment.

### DETAILED DESCRIPTION OF EMBODIMENTS

Hereinafter, an embodiment of the disclosure will be described with reference to the accompanying drawings. In this embodiment, it is assumed that the disclosure is applied to a power supply system which is mounted in a vehicle.

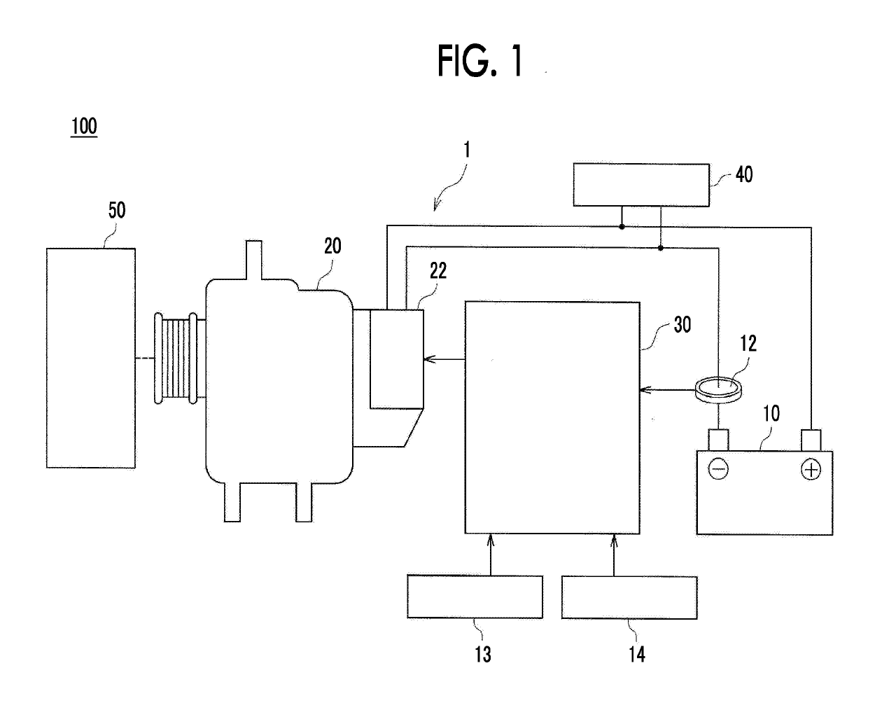

FIG. 1 is a diagram illustrating a system configuration of a vehicle controller 100 including a power supply system 1 according to the embodiment. The power supply system 1 includes a battery (an auxiliary machine battery) 10, an alternator (a power generator) 20, and an electronic control unit (ECU) 30.

The battery 10 is a chargeable and dischargeable secondary battery which is mounted in the vehicle and is, for example, a lead storage battery. The battery 10 is not limited to the lead storage battery, but may be another type of secondary battery.

A current sensor 12 is attached to one of a positive electrode line and a negative electrode line which are connected to the battery 10. The current sensor 12 detects a charging/discharging current of the battery 10 and outputs an output signal corresponding to the detected value to the ECU 30. In addition to the current sensor 12, a temperature sensor 13 that detects a temperature of the battery 10 and a voltage sensor 14 that detects an inter-terminal voltage of the battery 10 are connected to the ECU 30, and output signals corresponding to the detected values of the sensor 13 and 14 are output to the ECU 30.

The battery 10 supplies electric power to an on-board device 40. Examples of the on-board device 40 include an air conditioner, a car audio, and a navigation device. The battery 10 is charged with electric power generated by the alternator 20 (electric power generated by regenerative power generation and electric power generated by power generation using power of an engine 50 (fuel-injection power generation) which will be described later).

The alternator 20 is configured to generate electric power using power of an engine (an internal combustion engine) 50. Specifically, the alternator 20 includes an AC power generator that generates an alternating current by electromagnetic induction between a stator and a rotor thereof and a converter that converts the alternating current into a direct current. An IC regulator 22, which adjusts a current (an excitation current) supplied to an electromagnet (a field coil) of the rotor of the alternator 20 and controls a power generation voltage of the AC power generator, is attached to the alternator 20. The rotor of the alternator 20 is connected to a crank shaft of the engine 50 via a pulley or a belt to transmit power thereto. A control signal for the IC regulator 22 is output from the ECU 30.

The IC regulator 22 includes a comparator that compares the power generation voltage of the AC power generator with a voltage value indicated by the control signal output from the ECU 30 and a transistor that is turned on/off based on an output of the comparator. When the power generation voltage of the AC power generator is less than the voltage value indicated by the control signal, the transistor outputs an ON signal, an excitation current flows in the field coil to generate an electromotive force, and the power generation voltage of the AC power generator increases. On the other hand, when the power generation voltage of the AC power generator is greater than the voltage value indicated by the control signal, the transistor outputs an OFF signal, an excitation current does not flow in the field coil, and the power generation voltage of the AC power generator decreases. According to this configuration, the IC regulator 22 can control the power generation voltage of the alternator 20 to a desired voltage.

The ECU 30 is, for example, a microcomputer in which a central processing unit (CPU), a read only memory (ROM), a random access memory (RAM), and the like are connected to each other via a bus, and further includes a storage device such as a hard disc drive (HDD) or an electrically erasable and programmable read only memory (ROM), input/output ports, a timer, and a counter.

In addition to the current sensor 12, the temperature sensor 13, and the voltage sensor 14, a group of sensors such as a throttle opening degree sensor, an accelerator operation amount sensor, a crank position sensor, and a brake sensor are connected to the ECU 30. The group of sensors output output signals corresponding to detected values to the ECU 30.

The ECU 30 calculates a state of charge (SOC) of the battery 10 (hereinafter also referred to as a battery SOC) by integrating a current value input from the current sensor 12. The battery SOC may be corrected based on the output signal from the temperature sensor 13 or the voltage sensor 14.

The ECU 30 calculates a power generation voltage of the alternator 20 based on the output signals from the group of sensors and the battery SOC, and outputs the calculated power generation voltage as the above-mentioned control signal to the IC regulator 22. The power generation voltage of the alternator 20 is adjusted by feedback control which will be described later. The ECU 30 performs feedback control (feedback control based on the SOC of the battery 10) as management of the battery SOC. The feedback control is to adjust the power generation voltage (a power generation instructing voltage) when the alternator 20 performs power generation (particularly fuel-injection power generation) based on the battery SOC. Specifically, when the actual battery SOC is higher than a target battery SOC (hereinafter referred to as a target SOC), the control signal for setting the power generation voltage to be lower is output from the ECU 30 to the IC regulator 22. On the other hand, when the actual battery SOC is lower than the target SOC, the control signal for setting the power generation voltage to be higher is output from the ECU 30 to the IC regulator 22. Here, the target SOC is appropriately set (for example, set to 90%).

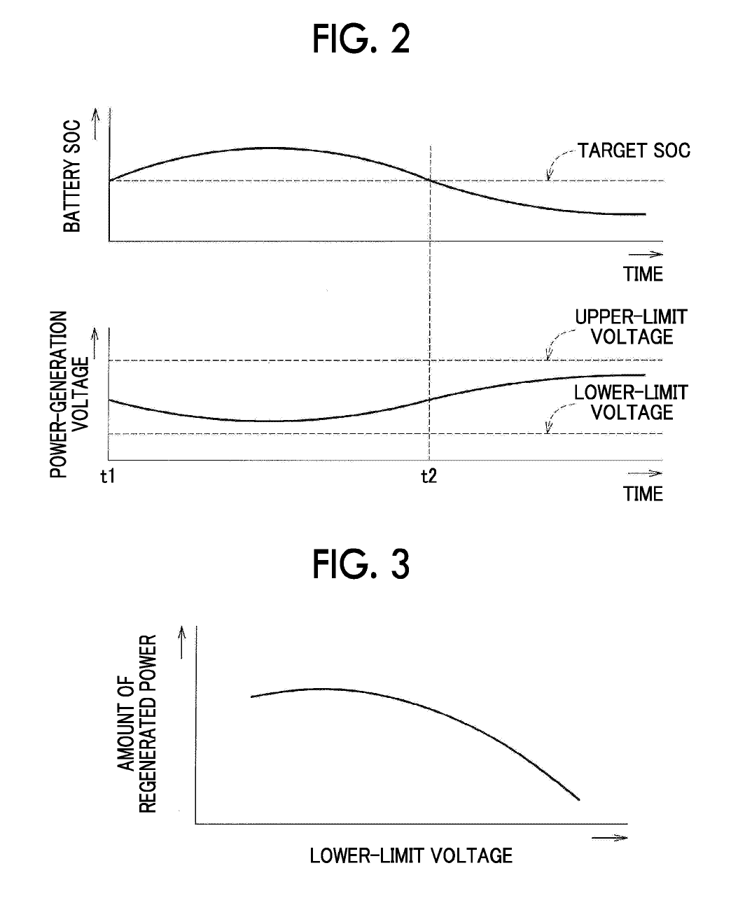

FIG. 2 is a graph illustrating an example of changes of the battery SOC and the power generation voltage. As illustrated in FIG. 2, the power generation voltage is adjusted between an upper-limit voltage (for example but not limited to, 13.5 V) and a lower-limit voltage (for example but not limited to, 12.5 V) depending on a difference between the target SOC and the actual battery SOC. In a period from time t1 to time t2 in FIG. 2, since the actual battery SOC is higher than the target SOC, the power generation voltage is set to be relatively lower depending on the difference and an amount of generated power (an amount of fuel-injection generated power) decreases. That is, in this period, the larger the difference becomes, the lower the power generation voltage is set to be. In a period after time t2 in FIG. 2, since the actual battery SOC is lower than the target SOC, the power generation voltage is set to be relatively high depending on the difference and the amount of generated power increases. That is, in this period, the larger the difference becomes, the higher the power generation voltage is set to be. In this embodiment, the lower-limit voltage is not a fixed value and is set depending on an amount of regenerated power which will be described later (more specifically, an average amount of regenerated power which will be described later). An operation of setting the lower-limit voltage will be described later.

In the feedback control, when the vehicle decelerates, the ECU 30 sets the power generation voltage (a power generation instructing voltage) of the alternator 20 to a relatively high value such as 14.8 V in order to actively charge the battery 10 by deceleration regeneration (regenerative power generation) to achieve an improvement in a fuel consumption rate. In this embodiment, the power generation voltage in the regenerative power generation (hereinafter referred to as a regenerative voltage) is not a fixed value, but is set depending on an integrated value of a charging/discharging current which will be described later. An operation of setting the regenerative voltage will also be described later.

The regenerative power generation of the alternator 20 is performed based on a regenerative power generation instructing signal from the ECU 30. Accordingly, the ECU 30 has a function of performing the regenerative power generation. That is, the ECU 30 is configured to cause a power generator to perform regenerative power generation and supplies the regenerated power to the secondary battery to charge the secondary battery.

The operation of setting the lower-limit voltage of the power generation voltage in the fuel-injection power generation which is a feature of this embodiment will be described below.

As described above, in JP 2016-005425 A, when an amount of regenerated power is large, the lower limit value of the target SOC is lowered, and thus there is a likelihood that an amount of fuel-injection generated power will increase with an improvement in power-receiving performance of the battery and the fuel consumption rate will deteriorate. In JP 2016-005425 A, since the balance of electric power for the battery has a charging tendency, deterioration of the battery is likely to progress.

In this embodiment, an improvement in the fuel consumption rate of the engine 50 and prevention of deterioration of the battery 10 are achieved in consideration of the above-mentioned circumstances. Specifically, the above-mentioned problem is solved by optimizing the power generation voltage (more specifically, the lower-limit voltage of the power generation voltage) when the fuel-injection power generation using the power of the engine 50 is performed.

When the lower limit value (the lower-limit voltage) of the power generation voltage at the time of performing the fuel-injection power generation is excessively decreased and the power generation voltage reaches the lower limit value, charging of the battery 10 is hardly performed (or an amount of power discharged from the battery 10 increases). Accordingly, the power generation voltage increases greatly due to the feedback control (the feedback control of the power generation voltage for causing the battery SOC to reach the target SOC). Even when the regenerative power generation is performed thereafter, charging polarization occurs in the battery 10 before the regenerative power generation is started and thus the power supply system cannot obtain a sufficient amount of regenerated power. The inventors of the disclosure obtained the following new knowledge with a focus on the above-mentioned problem. By optimizing the lower-limit voltage, it is possible to obtain a sufficient amount of regenerated power, to decrease the amount of fuel-injection generated power, and thus to achieve an improvement in fuel consumption rate.

FIG. 3 is a diagram illustrating an example of a relationship between the lower-limit voltage of the power generation voltage when the fuel-injection power generation is performed and the amount of regenerated power when the regenerative power generation is performed. The relationship between the lower-limit voltage of the power generation voltage and the amount of regenerated power in FIG. 3 was obtained by experiment or simulation. As illustrated in FIG. 3, as the lower-limit voltage of the power generation voltage decreases, the amount of fuel-injection generated power decreases and thus the amount of regenerated power increases, but the amount of regenerated power decreases as the lower-limit voltage decreases when the lower-limit voltage is in a range which is equal to or lower than a predetermined value. This can be estimated to be caused due to occurrence of the above-mentioned charging polarization. In this way, there is a value of the lower-limit voltage at which an effect of increasing the amount of regenerated power with the decrease of the lower-limit voltage is saturated. Accordingly, by setting the lower-limit voltage to be as low as possible in a range in which charging polarization does not occur, the largest amount of regenerated power can be set and the amount of fuel injected into the engine 50 can be minimized.

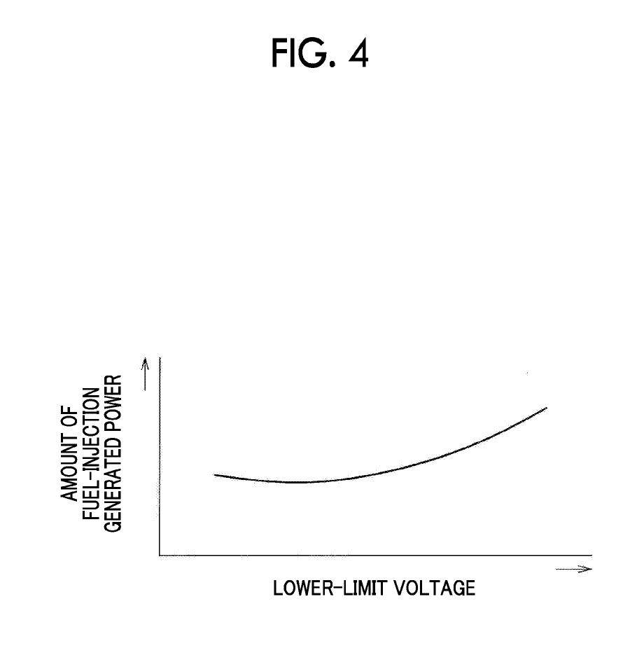

FIG. 4 is a diagram illustrating an example of a relationship between the lower-limit voltage of the power generation voltage when the fuel-injection power generation is performed and the amount of fuel-injection generated power when the fuel-injection power generation is performed. The relationship between the lower-limit voltage of the power generation voltage and the amount of fuel-injection generated power in FIG. 4 was also obtained by experiment or simulation. As illustrated in FIG. 4, as the lower-limit voltage of the power generation voltage decreases, the amount of fuel-injection generated power decreases, but the amount of fuel-injection generated power increases as the lower-limit voltage decreases when the lower-limit voltage is in a range which is equal to or less than a predetermined value. A reason for this phenomenon can be estimated as follows. The amount of regenerated power is determined to a certain degree depending on performance of the alternator 20 or the battery 10. Accordingly, when the lower-limit voltage decreases excessively, an amount of discharged power increases and the amount of fuel-injection generated power increases. In this way, there is a value of the lower-limit voltage at which an effect of decreasing amount of fuel-injection generated power decreases with the decrease of the lower-limit voltage is saturated. Accordingly, by setting the lower-limit voltage to be as low as possible in a range in which the amount of fuel-injection generated power does not increase (in a range in which the amount of fuel-injection generated power decreases as the lower-limit voltage decreases), the amount of fuel injected into the engine 50 can be minimized.

As described above, the inventors of the disclosure found that the lower-limit voltage at which the amount of fuel-injection generated power can be minimized varies depending on the magnitude of the amount of regenerated power. In this embodiment, in consideration of this knowledge, the lower-limit voltage when the alternator 20 performs power generation using the power of the engine 50 (the fuel-injection power generation) is variably set to a voltage at which the amount of fuel injected into the engine 50 is minimized (a lower-limit voltage at which the amount of fuel-injection generated power is minimized) depending on the amount of regenerated power supplied to the battery 10. Specifically, by setting the lower-limit voltage when the fuel-injection power generation is performed to be lower as the amount of regenerated power (an average amount of regenerated power which will be described later) supplied to the battery 10 decreases, the lower-limit voltage can be set to be as low as possible in a range in which the charging polarization does not occur to minimize the amount of fuel-injection generated power.

The operation of setting the lower-limit voltage is performed by the ECU 30. Accordingly, the ECU 30 has a function of setting the lower-limit voltage. That is, the ECU 30 is configured to cause the power generator to perform power generation using power of an internal combustion engine on the basis of a power generation voltage set by feedback control and supply the generated electric power to the secondary battery to charge the secondary battery. The ECU 30 is also configured to set the lower-limit voltage, when the power generator performs power generation using the power of the internal combustion engine, to a voltage at which the amount of fuel injected into the internal combustion engine is minimized depending on the amount of regenerated power supplied to the secondary battery.

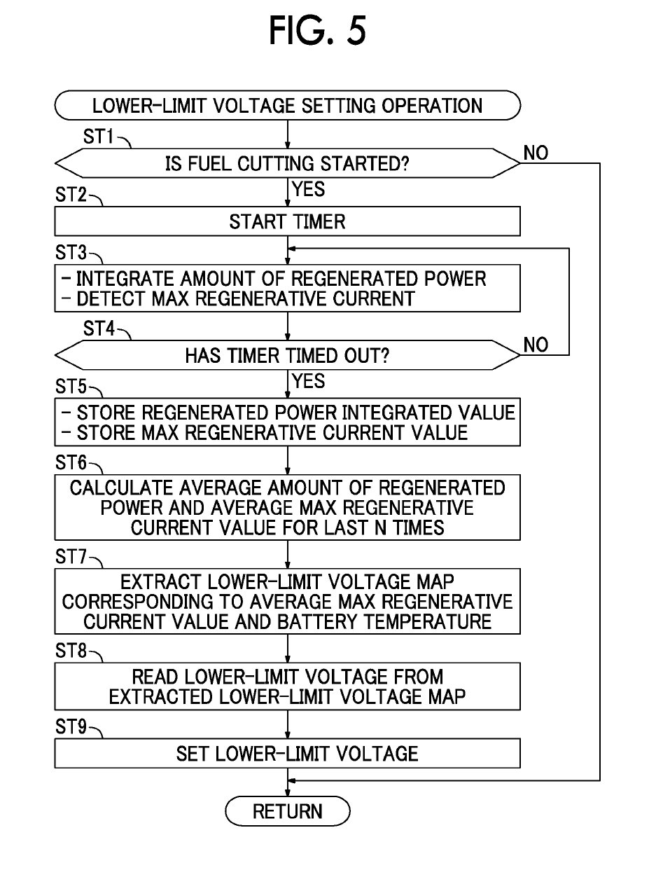

The operation of setting the lower-limit voltage will be described below with reference to the flowchart illustrated in FIG. 5. This flowchart is repeatedly performed at a predetermined cycle of time after the engine 50 is started.

First, in Step ST1, it is determined whether fuel cutting (stop of fuel injection) of the engine 50 is started. A starting condition of the fuel cutting is satisfied, for example but not limited to, when a rotation speed of the engine 50 is equal to or higher than a predetermined value and an accelerator-OFF operation is performed. The rotation speed of the engine 50 is calculated based on an output signal from the crank position sensor. An accelerator operation amount is detected based on an output signal from the accelerator opening degree sensor.

When the fuel cutting of the engine 50 is not started and the determination result of Step ST1 is NO, the process routine restarts as it is. In this case, the currently set lower-limit voltage of the power generation voltage (the lower-limit voltage set as an initial value or the lower-limit voltage set in the previous routine) is maintained. That is, without updating the lower-limit voltage of the power generation voltage, the lower-limit voltage when the fuel-injection power generation is performed is maintained at the currently set value.

When the fuel cutting of the engine 50 is started and the determination result of Step ST1 is YES, the timer provided in advance in the ECU 30 is started in Step ST2. The timer times out, for example, several seconds after it has been started.

After the timer is started, an amount of power regenerated by deceleration regeneration (regenerative power generation) of the vehicle accompanied with start of the fuel cutting is integrated in Step ST3. That is, the amount of regenerated power is integrated in a period until the timer times out in Step ST4 which will be described later. A maximum value of the regenerative current (a max regenerative current) after the timer is started is detected. That is, the max regenerative current is updated in a period until the timer times out in Step ST4 which will be described later. The amount of regenerated power is calculated based on the output signal from the current sensor 12, the output signal from the voltage sensor 14, and the like. For example, the amount of regenerated power is calculated, for example, by a calculation expression “regenerative current×battery voltage.” The max regenerative current is calculated based on the output signal from the current sensor 12.

In Step ST4, it is determined whether the timer has timed out. In a period in which the timer has not timed out and the determination result of Step ST4 is NO, the operation of Step ST3 is continuously performed. That is, the amount of regenerated power is integrated and the max regenerative current is updated.

When the timer has timed out and the determination result of Step ST4 is YES, the integrated amount of regenerated power (hereinafter referred to as a regenerated power integrated value) is stored in the RAM and the value of the max regenerative current (a maximum value of the regenerative current in the period until the timer times out; hereinafter simply referred to as a max regenerative current value) is stored in the RAM, in Step ST5.

Thereafter, in Step ST6, an average value (an average amount of regenerated power; a moving average of the regenerated power integrated values) of the regenerated power integrated values (the values in N times of the regenerated power integrated value which is stored whenever the timer times out) for the last N times (for example, 10 times) is calculated, and an average value (an average max regenerative current value; a moving average of the max regenerative current values) of the max regenerative current values for the last N times (the values in N times of the max regenerative current value which is stored whenever the timer times out) is calculated.

Thereafter, in Step ST7, a lower-limit voltage map corresponding to the average max regenerative current value and the battery temperature is extracted. The lower-limit voltage map is a map for defining the lower-limit voltage of the power generation voltage depending on the average amount of regenerated power. A plurality of lower-limit voltage maps depending on the average max regenerative current value and the battery temperature are stored in the ROM. The lower-limit voltage maps are prepared (adapted) by acquiring the lower-limit voltage of the power generation voltage at which the amount of fuel injected into the engine 50 is minimized (the amount of fuel-injection generated power is minimized) depending on the average amount of regenerated power by experiment or simulation.

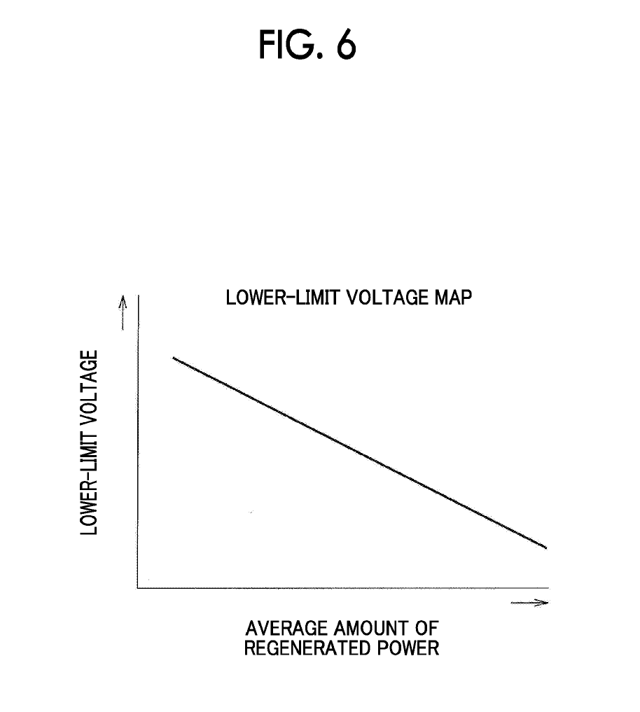

FIG. 6 is a diagram illustrating an example of one lower-limit voltage map (a lower-limit voltage map at a predetermined average max regenerative current value and a predetermined battery temperature). As illustrated in FIG. 6, the horizontal axis of the lower-limit voltage map represents the average amount of regenerated power and the vertical axis thereof represents the lower-limit voltage. As the average amount of regenerated power increases, the lower-limit voltage is set to be lower.

That is, the lower-limit voltage map is a map for decreasing the amount of fuel-injection generated power to achieve an improvement in fuel consumption rate by setting the lower-limit voltage to be low in a situation in which the average amount of regenerated power is large and the amount of fuel-injection generated power can be decreased. The lower-limit voltage map is a map for setting the lower-limit voltage to be higher such that the charging polarization is less likely to occur in a situation in which the average amount of regenerated power is small.

A plurality of lower-limit voltage maps are stored depending on the average max regenerative current values and the battery temperatures. Each lower-limit voltage map is defined to set the lower-limit voltage to be lower as the average max regenerative current value becomes larger even when the average amount of regenerated power is the same. Each lower-limit voltage map is defined to set the lower-limit voltage to be lower as the battery temperature becomes higher even when the average amount of regenerated power is the same. That is, when the average max regenerative current value is large, the lower-limit voltage is set to be lower than when the average max regenerative current value is small. When the battery temperature is high, the lower-limit voltage is set to be lower than when the temperature is low.

The reason for setting the lower-limit voltage to be lower as the average max regenerative current value becomes larger is as follows. That is, when the average max regenerative current is large, the charging polarization of the battery 10 before the regenerative power generation is started is sufficiently small and a sufficient amount of regenerated power is obtained. Accordingly, when the average max regenerative current value is large, the lower-limit voltage can be set to be lower than when the average max regenerative current value is small and thus the amount of fuel-injection generated power can be decreased to achieve an improvement in fuel consumption rate.

The reason for setting the lower-limit voltage to be lower as the battery temperature becomes higher is as follows. When the battery temperature is high, a chemical reaction in the battery 10 is activated and the power-receiving performance thereof increases, and thus the lower-limit voltage is set to be low. That is, it is possible to set an optimal lower-limit voltage depending on the battery temperature (a lower-limit voltage which is a lowest possible voltage in a range in which the charging polarization can be prevented) and to decrease the amount of fuel-injection generated power to achieve an improvement in fuel consumption rate.

When degrees of influence of the average amount of regenerated power and the average max regenerative current value on the lower-limit voltage are compared, the average amount of regenerated power is greatly affected by traveling conditions, weather, and performance of the battery 10 and the alternator 20. The average max regenerative current value is greatly affected by performance of the battery 10 and the alternator 20. That is, the average max regenerative current value is not easily affected by traveling conditions and weather, and a power generation potential increases. Accordingly, a degree of influence when the lower-limit voltage is changed is set to be larger on the average max regenerative current value than on the average amount of regenerated power.

After the lower-limit voltage map is extracted in Step ST7, the lower-limit voltage is read from the extracted lower-limit voltage map in Step ST8. That is, the lower-limit voltage is read by applying the average amount of regenerated power calculated in Step ST6 to the extracted lower-limit voltage map.

In Step ST9, the read lower-limit voltage is set as a lower-limit voltage when the fuel-injection power generation is performed in the next time. For example, when the fuel-injection power generation is performed by the alternator 20 in a situation in which an accelerator pedal is depressed and the vehicle accelerates or travels normally, the lower-limit voltage of the power generation voltage in the fuel-injection power generation is set to the lower-limit voltage read from the lower-limit voltage map.

When the power generation voltage increases greatly due to feedback control of the power generation voltage, charging polarization occurs in the battery 10. The charging polarization is minimized by the method of setting the lower-limit voltage of the power generation voltage. That is, it is possible to prevent charging polarization of the battery 10 from occurring before the regenerative power generation is started and to obtain a sufficient amount of regenerated power at the time of performing the regenerative power generation. As a result, it is possible to decrease the amount of fuel-injection generated power and to achieve an improvement in fuel consumption rate.

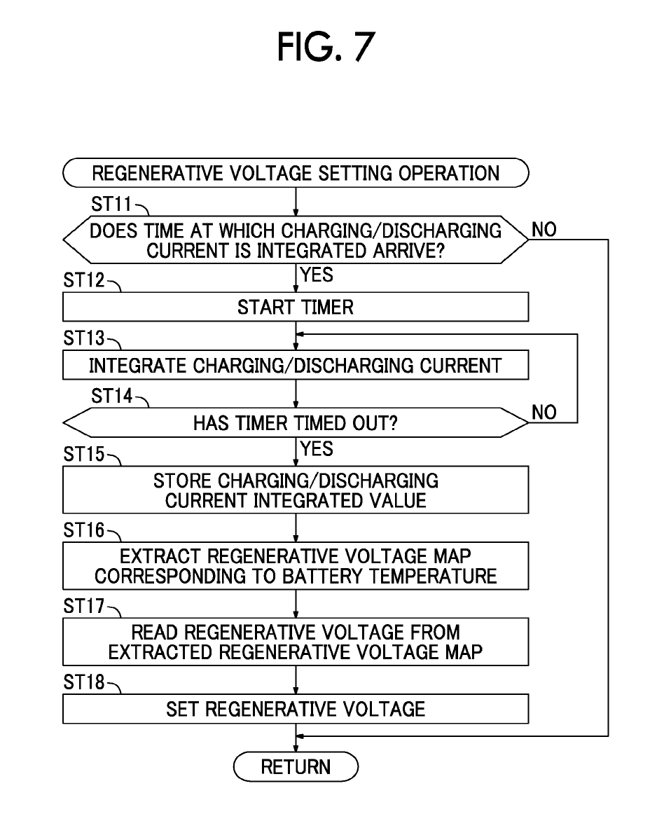

The process routine of setting a regenerative voltage at the time of performing the regenerative power generation will be described below with reference to the flowchart illustrated in FIG. 7. The operation of setting a regenerative voltage is an operation for preventing overcharging of the battery 10 to minimize deterioration of the battery 10. This flowchart is also repeatedly performed at a predetermined cycle of time after the engine 50 is started.

First, in Step ST11, it is determined whether a time at which integration of a charging/discharging current of the battery 10 is started arrives. The time at which integration of a charging/discharging current is started is set, for example, as a time which arrives every several tens of seconds in advance. That is, the operations after Step ST12 are performed when the time at which the integration is started arrives after the engine 50 is started.

When the time at which the integration of a charging/discharging current is started does not arrive and the determination result of Step ST11 is NO, the process routine restarts as it is. In this case, the currently set regenerative voltage (the regenerative voltage set as an initial value or the regenerative voltage set in the previous routine) is maintained. That is, without updating the regenerative voltage, the regenerative voltage when the regenerative power generation is performed is maintained at the currently set value.

When the time at which the integration of a charging/discharging current is started arrives and the determination result of Step ST11 is YES, the timer provided in the ECU 30 in advance is started in Step ST12. The timer times out, for example, in several tens of seconds (which is a time shorter than the cycle of the time at which the integration of a charging/discharging current is started) after it is started.

After the timer is started, the charging/discharging current is integrated in Step ST13. That is, the charging/discharging current of the battery 10 is integrated in a period until the timer times out in Step ST14 which will be described later. The charging/discharging current is calculated based on the output signal from the current sensor 12 or the like.

In Step ST14, it is determined whether the timer has timed out. In the period in which the timer has not timed out and the determination result of Step ST14 is NO, the operation of Step ST13 continues to be performed. That is, the charging/discharging current of the battery 10 is integrated.

When the timer has timed out and the determination result of ST14 is YES, the integrated charging/discharging current (a charging/discharging current integrated value) is stored in the RAM in Step ST15.

Thereafter, in Step ST16, a regenerative voltage map corresponding to the battery temperature is extracted. The regenerative voltage map is a map for defining the regenerative voltage depending on the charging/discharging current integrated value, and a plurality of regenerative voltage maps corresponding to the battery temperature is stored in the ROM. The regenerative voltage map is prepared (adapted) by acquiring a regenerative voltage at which the overcharging of the battery 10 is minimized depending on the charging/discharging current integrated value by experiment or simulation.

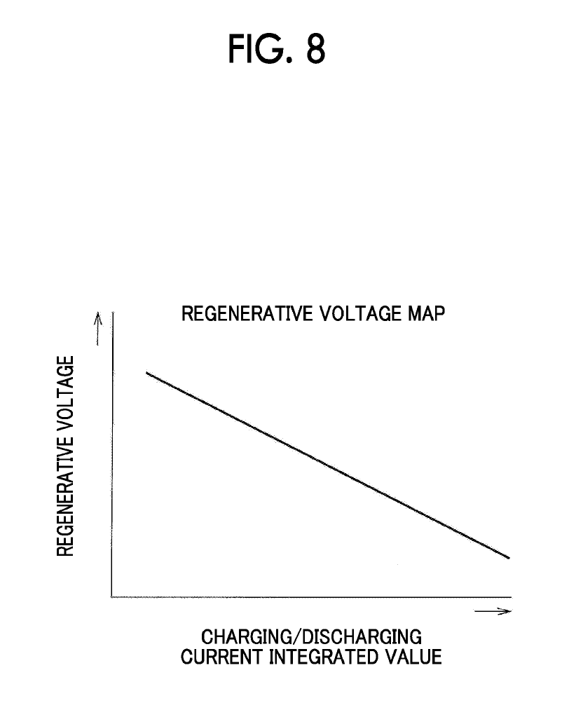

FIG. 8 is a diagram illustrating an example of one regenerative voltage map (a regenerative voltage map at a predetermined battery temperature). As illustrated in FIG. 8, the horizontal axis of the regenerative voltage map represents the charging/discharging current integrated value and the vertical axis represents the regenerative voltage. The larger the charging/discharging current integrated value becomes, the lower the regenerative voltage is set to be.

A plurality of regenerative voltage maps corresponding to the battery temperature are stored. In each regenerative voltage map, the regenerative voltage is set to be lower as the battery temperature becomes higher even when the charging/discharging current integrated value is the same. That is, when the battery temperature is high, the regenerative voltage is set to be lower than when the temperature is low.

The reason for setting the regenerative voltage to be lower as the battery temperature becomes higher is as follows. When the battery temperature is high, a chemical reaction in the battery 10 is activated, the charging/discharging current increases, and deterioration of the battery 10 is likely to progress. Accordingly, by setting the regenerative voltage to be lower when the battery temperature is high than when the battery temperature is low, it is possible to suppress an increase in the charging/discharging current. Accordingly, it is possible to make deterioration of the battery 10 less likely to progress and to extend the lifespan of the battery 10. In order to secure a sufficient SOC of the battery 10, in the regenerative voltage map, the regenerative voltage is defined to be higher as the battery temperature becomes lower. When the battery temperature is low, there is a likelihood that the power-receiving performance of the battery 10 will be lowered and the balance of charging/discharging power of the battery 10 will deteriorate. As a result, when the regenerative voltage is set to be high, it is possible to obtain a sufficient amount of regenerated power and thus to satisfactorily secure a SOC of the battery 10.

After the regenerative voltage map is extracted in Step ST16, the regenerative voltage is read from the extracted regenerative voltage map in Step ST17. That is, the regenerative voltage is read by applying the charging/discharging current integrated value stored in Step ST15 to the extracted regenerative voltage map.

In Step ST18, the read regenerative voltage is set as the regenerative voltage when the regenerative power generation is performed in the next time. For example, in a situation in which an accelerator-OFF operation is performed and the vehicle decelerates, the regenerative voltage in the regenerative power generation is set to the regenerative voltage read from the regenerative voltage map.

Since the regenerative voltage is set in this way, it is possible to minimize an increase of the charging/discharging current in the regenerative power generation and to make deterioration of the battery 10 less likely to progress to achieve extension of a lifespan of the battery 10.

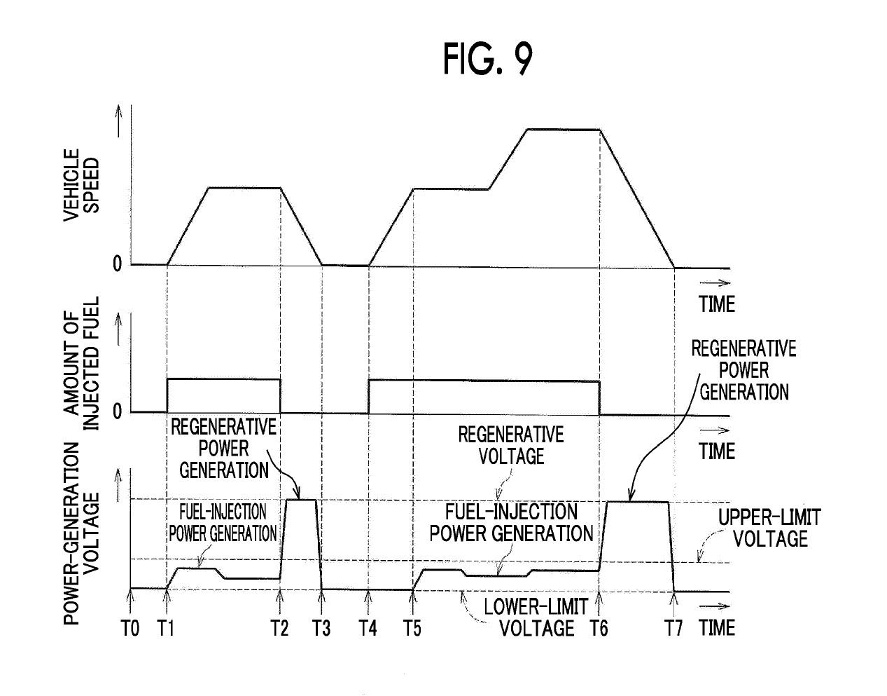

FIG. 9 is a timing chart illustrating an example of changes a vehicle speed, an amount of injected fuel, and a power generation voltage when a lower-limit voltage of the power generation voltage is set in this embodiment.

In FIG. 9, in a period from time T0 to time T1, a period from time T3 to T4, and a period after time T7, the vehicle stops and the engine 50 is in an idling stop state. Accordingly, in such periods, the amount of injected fuel is set to “0,” and the amount of generated power (the amount of fuel-injection generated power and the amount of regenerated power) is set to “0.”

In a period from time T2 to time T3 and a period from time T6 to time T7, the vehicle decelerates and deceleration regeneration (regenerative power generation) is performed. Accordingly, in such periods, the amount of injected fuel is set to “0,” the power generation voltage in the regenerative power generation (the regenerative voltage) is set to a relatively high value (for example, 14.8 V), and charging of the battery 10 by the regenerative power generation is actively performed.

In a period from time T1 to time T2 and a period from time T4 to time T6, the vehicle accelerates or travels normally, the power generation voltage is adjusted between the upper-limit voltage (for example, 13.5 V) and the lower-limit voltage (for example, 12.5 V) by the feedback control, and the fuel-injection power generation is performed. Accordingly, in such periods, the fuel-injection power generation is performed, and the lower-limit voltage of the power generation voltage in the fuel-injection power generation is set to a value based on the average amount of regenerated power as described above. Particularly, in a period from time T4 to time T5, the power generation voltage in the fuel-injection power generation is limited by the lower-limit voltage such that the power generation voltage is not lower than the lower-limit voltage. The lower-limit voltage is set to a value at which occurrence of the charging polarization is prevented and the amount of fuel-injection generated power is decreased by obtaining a sufficient amount of regenerated power.

In this way, in the period from time T4 to time T6, since the power generation voltage is limited by the lower-limit voltage, the power generation voltage does not increase greatly due to the feedback control of the power generation voltage, and occurrence of the charging polarization in the battery 10 in the period is minimized. Accordingly, since a sufficient amount of regenerated power in subsequent regenerative power generation (the regenerative power generation from time T6 to time T7) is obtained, it is possible to decrease the amount of fuel-injection generated power and thus to achieve an improvement in fuel consumption rate.

As described above, in this embodiment, by achieving optimization of the lower-limit voltage when the fuel-injection power generation is performed, it is possible to prevent charging polarization from occurring in the battery 10 before the regenerative power generation is started (minimize charging polarization due to the feedback control of the power generation voltage) and to obtain a sufficient amount of regenerated power at the time of performing the regenerative power generation. Accordingly, it is possible to decrease the amount of fuel-injection generated power and thus to achieve an improvement in fuel consumption rate. Since the target SOC is not changed (the target SOC is changed depending on the amount of regenerated power in JP 2016-005425 A), it is possible to minimize deterioration of the battery 10 due to an excessive amount of regenerated power and to prevent deterioration of a regeneration efficiency due to an excessive SOC.

In this embodiment, when the average amount of regenerated power supplied to the secondary battery is large, the lower-limit voltage is set to be lower than when the average amount of regenerated power supplied to the secondary battery is small. Accordingly, in a situation in which the average amount of regenerated power is large and the amount of fuel-injection generated power can be relatively reduced, the lower-limit voltage is set to be low. As a result, it is possible to decrease the amount of fuel-injection generated power and to achieve an improvement in fuel consumption rate. In a situation in which the average amount of regenerated power is small, the lower-limit voltage is set to be high. Accordingly, the charging polarization is less likely to occur.

In this embodiment, when the battery temperature is high, the lower-limit voltage is set to be lower than when the battery temperature is low. Accordingly, the lower-limit voltage can be set to an optimal lower-limit voltage (a lower-limit voltage which is a lowest possible voltage in a range in which charging polarization can be prevented) depending on the battery temperature and it is possible to decrease the amount of fuel-injection generated power and to achieve an improvement in fuel consumption rate.

In this embodiment, when the average max regenerative current value is large, the lower-limit voltage is set to be lower than when the average max regenerative current value is small. That is, when the charging polarization in the battery 10 before the regenerative power generation is started is sufficiently small, a sufficient amount of regenerated power can be obtained and thus the lower-limit voltage is set to be low. Accordingly, it is possible to decrease the amount of fuel-injection generated power and to achieve an improvement in fuel consumption rate.

In this embodiment, when the battery temperature is high, the regenerative voltage in the regenerative power generation is set to be lower than when the battery temperature is low. Accordingly, it is possible to minimize an increase in a charging/discharging current of the battery 10 to make deterioration of the battery 10 less likely to progress and to achieve extension of a lifespan of the battery 10. When the battery temperature is low, the regenerative voltage in the regenerative power generation is set to be higher than when the battery temperature is high. Accordingly, even at a low temperature at which activity of a chemical reaction in the battery 10 is low, the SOC of the battery 10 can be satisfactorily secured by obtaining a sufficient amount of regenerated power.

In this embodiment, when an integrated value of a charging/discharging current of the secondary battery is large, the regenerative voltage in the regenerative power generation is set to be lower than when the integrated value of the charging/discharging current of the secondary battery is small. Accordingly, it is possible to minimize an increase in the charging/discharging current and to make deterioration of the secondary battery difficult to progress. Accordingly, it is possible to extend the lifetime of the secondary battery.

The disclosure is not limited to the above-mentioned embodiment, but can be subjected to all modifications or applications which are included in the scope of the appended claims and scopes equivalent to the scope.

For example, in the above-mentioned embodiment, the lower-limit voltage of the fuel-injection power generation is set using the average amount of regenerated power, the average max regenerative current value, and the battery temperature as parameters. The disclosure is not limited thereto. The power supply system may set the lower-limit voltage in the fuel-injection power generation using only the average amount of regenerated power and the average max regenerative current value as parameters. The power supply system may set the lower-limit voltage in the fuel-injection power generation using only the average amount of regenerated power and the battery temperature as parameters.

In the above-mentioned embodiment, the regenerative voltage is set using the charging/discharging current integrated value and the battery temperature as parameters. However, the disclosure is not limited thereto. The power supply device may set the regenerative voltage using only the charging/discharging current integrated value as a parameter.

The disclosure is applicable to adjustment of a lower-limit voltage of a power generation voltage for achieving an improvement in fuel consumption rate.

What is claimed is:

1. A power supply system comprising:
a power generator configured to charge a secondary battery; and
an electronic control unit configured to:
i) cause the power generator to perform regenerative power generation and supply regenerated power to the secondary battery to charge the secondary battery;
ii) cause the power generator to perform fuel power generation using power of an internal combustion engine and supply generated power to the secondary battery to charge the secondary battery, the fuel power generation being performed based on a power generation voltage which is set due to feedback control based on a state of charge of the secondary battery; and
iii) set a lower-limit voltage when the fuel power generation is performed, depending on an amount of the regenerated power supplied to the secondary battery, to a voltage at which an amount of fuel injected into the internal combustion engine is minimized.

2. The power supply system according to claim 1, wherein the electronic control unit is configured to set the lower-limit voltage to be lower when an average value of the amount of the regenerated power supplied to the secondary battery is large than when the average value of the amount of the regenerated power supplied to the secondary battery is small.

3. The power supply system according to claim 1, wherein the electronic control unit is configured to set the lower-limit voltage to be lower when a temperature of the secondary battery is high than when the temperature is low.

4. The power supply system according to claim 1, wherein:
the electronic control unit is configured to set the lower-limit voltage to be lower when an average value of a maximum value of a regenerative current in a predetermined period is large than when the average value of the maximum value of the regenerative current in the predetermined period is small, the regenerative current being a current of the regenerative power generation; and
the maximum value of the regenerative current is detected every time when predetermined time elapse.

5. The power supply system according to claim 1, wherein the electronic control unit is configured to set a regenerative voltage at a time of the regenerative power generation to be lower when a temperature of the secondary battery is high than when the temperature of the secondary battery is low, the regenerative voltage being a voltage of the regenerative power generation.

6. The power supply system according to claim 5, wherein the electronic control unit is configured to set the regenerative voltage at the time of the regenerative power generation to be lower when an integrated value of a charging/discharging current of the secondary battery is large than when the integrated value of the charging/discharging current of the secondary battery is small.
